(19) United States
(12) Patent Application Publication
(10) Pub. No.: US 2005/0076062 A1
(43) Pub. Date: Apr. 7, 2005

(54) Image server and method of controlling same

(76) Inventor: Tetsuya Sawano, Asaka-shi (JP)

Correspondence Address: BIRCH STEWART KOLASCH & BIRCH, PO BOX 747, FALLS CHURCH, VA, 22040-0747, US

(21) Appl. No.: 10/957,676

(22) Filed: Oct. 5, 2004

(30) Foreign Application Priority Data
Oct. 6, 2003 (JP) 2003-346759

(51) Int. Cl. G06F 7/00

(52) U.S. Cl. 707/104.1

(57) ABSTRACT

E-mail to which an image file has been attached is transmitted from a mobile telephone, which is equipped with a camera, to an image server. The image server receives the e-mail and, if the image file is not an EXIF file, formats the file as an EXIF file. The image data is read from the EXIF file and thumbnail image data is generated by the image server. The generated thumbnail image data is recorded in the header area of the EXIF file. The EXIF file is then transmitted from the image server to an image file receiving apparatus. Since thumbnail image data is not contained in the header of the image file transmitted to the image server from the mobile telephone having the camera, the amount of data in the image file is reduced.

### BACKGROUND OF THE INVENTION

1. Field of the Invention

This invention relates to an image server, a method of controlling the image server and a program for controlling the image server.

2. Description of the Related Art

An EXIF (Exchangeable Image File Format) file generated by sensing the image of a subject using a digital still camera or the like includes a header area and an image-data recording area. Image data is recorded in the image-data recording area. EXIF file management information and thumbnail image data of the image data that has been recorded in the image-data recording area, etc., is recorded in the header area (see the specification of Japanese Patent Application Laid-Open No. 2003-219346).

A problem which arises is that when the amount of data recorded in the header area is large, transmission time is prolonged as when the EXIF file is uploaded to an image server.

### SUMMARY OF THE INVENTION

Accordingly, an object of the present invention is to shorten the transmission time of an image file.

According to the present invention, the foregoing object is attained by providing an image server comprising: a receiving device for receiving an image file transmitted from a portable image sensing device and including a header area and an image-data recording area; a generating device for generating thumbnail image data using image data that has been recorded in the image-data recording area of the image file received by the receiving device; a first recording controller for recording the thumbnail image data, which has been generated by the generating device, in the header area of the image file; and a transmitting device for transmitting the image file, in the header area of which the thumbnail image data has been recorded by the first recording controller, to an image file receiving apparatus.

The present invention also provides a method of control suited to the above-described mage server. Specifically, the present invention provides a method of controlling an image server comprising the steps of: receiving an image file transmitted from a portable image sensing device and including a header area and an image-data recording area; generating thumbnail image data using image data that has been recorded in the image-data recording area of the image file received; recording the generated thumbnail image data in the header area of the image file; and transmitting the image file, in the header area of which the thumbnail image data has been recorded, to an image file receiving apparatus.

Further, the present invention also provides a program for controlling the above-described image server as well as a recording medium on which this program has been recorded.

In accordance with the present invention, an image file containing a header area and an image-data recording area is transmitted from a portable image sensing device (a mobile telephone equipped with a camera, a digital still camera, etc.) to an image server. The image file that has been transmitted from the portable image sensing device is received by the image server. Image data that has been recorded in the image-data recording area contained in the received image file is read by the image server and thumbnail image data is generated. The generated thumbnail image data is recorded in the header recording area of the image file. The image file having the header recording area in which the thumbnail image data has been recorded is transmitted from the image server to an image file receiving apparatus (a mobile telephone equipped with a display device, a personal computer, etc.).

Since thumbnail image data is generated and the generated thumbnail image data recorded in the header recording area of the image file by the image server, it is unnecessary for the thumbnail image data to have been recorded in the header area of the image file transmitted from the portable image sensing device. Thus the amount of data in the image file is reduced. In a situation where an image file is transmitted from a portable image sensing device to an image server, therefore, transmission time can be shortened. Further, since an image file in the header area of which thumbnail image data has been recorded is transmitted to an image file receiving apparatus, the latter can obtain the thumbnail images without generating thumbnail image data.

The receiving device preferably receives the image file and model information pertaining to the portable image sensing device. In this case the image server would further comprise a correcting device for correcting the image data, which has been recorded in the image-data recording area of the image file received by the receiving device, in accordance with the model information received by the receiving device; and a second recording controller for recording the image data, which has been corrected by the correcting device, in the image-data recording area of the image file. The generating device would generate thumbnail image data using the image data that has been corrected by the correcting device.

Since thumbnail image data is generated using the corrected image data, an image represented by the image data and a thumbnail image represented by the thumbnail image data will both have been subjected to a correction conforming to the model of the portable image sensing device. Since the image and the thumbnail image thereof will both have undergone the same correction, a difference in color tone between the two images can be prevented.

The receiving device may receive an image file together with the model information pertaining to the portable image sensing device used at the time the image file was obtained and data representing date of photography and amount of zoom. In this case the first recording controller would record the thumbnail image data in the header area together with the model information and data representing the date of photography and amount of zoom.

Even if model information, date of photography and amount of zoom have not been recorded in the header recording area of an image file transmitted from the portable image sensing device, an image file in the header area of which model information, etc., has been stored can be generated. For example, the model information pertaining to the portable image sensing device and the data representing the date of photography and amount of zoom can be recorded in the header area of e-mail and the image file can be made an image file that is attached to this e-mail.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates the overall configuration of an image communication system;

FIG. 2 is a flowchart illustrating processing executed by a mobile telephone equipped with a camera and by an image server;

FIG. 3 illustrates the file structure of an e-mail file;

FIG. 4 illustrates the file structure of an image file; and

FIG. 5 illustrates the file structure of an EXIF file.

### DESCRIPTION OF THE PREFERRED EMBODIMENT

A preferred embodiment of the present invention will now be described in detail with reference to the accompanying drawings.

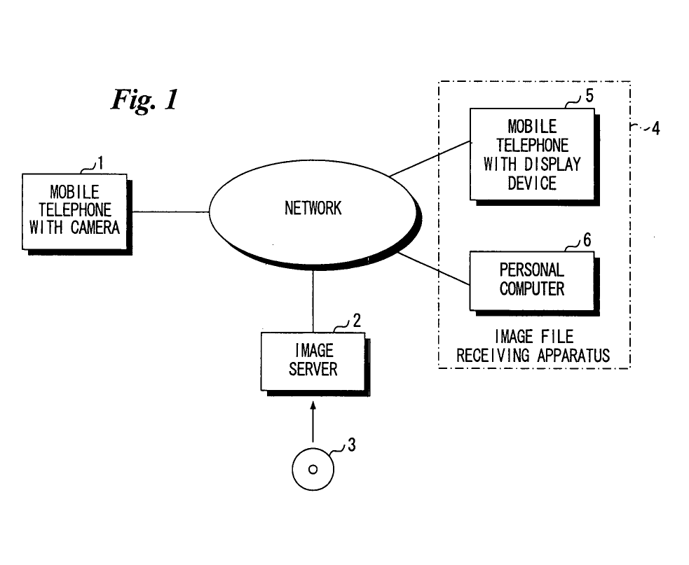

FIG. 1, which illustrates a preferred embodiment of the present invention, shows the overall configuration of an image communication system.

The image communication system includes a mobile telephone 1 equipped with a camera, an image server 2 and an image file receiving apparatus 4. These are capable of communicating with one another via a network. A mobile telephone 5 equipped with a display device and a personal computer 6 are illustrated as the image file receiving apparatus 4.

A program that has been stored on a CD-ROM (Compact Disc-Read Only Memory) 3 is installed in the image server 2, whereby the image server 2 performs an operation described later.

It goes without saying that the image server 2 includes a communication circuit for communicating with the mobile telephone 1 having the camera and with the image file receiving apparatus 4 such as the mobile telephone 5 having the display device and the personal computer 6; a CPU for executing image processing; and a memory for storing data temporarily.

In this embodiment, e-mail to which an image file has been attached is transmitted to the image server 2 from the mobile telephone 1 equipped with the camera. The image server 2 generates thumbnail image data from image data that has been recorded in the image file attached to the e-mail. The generated thumbnail image data is recorded in a header area of the image file. The image file in which the thumbnail image data has been recorded is transmitted from the image server 2 to the image file receiving apparatus 4. Thus, even though thumbnail image data has not been recorded in the header area of the image file transmitted from the mobile telephone 1 having the camera, an image file in the header area of which thumbnail image data will have been recorded is transmitted to the image file receiving apparatus 4. Since the amount of data in the header area is reduced, time for transmission from the mobile telephone 1 having the camera to the image server 2 is shortened. The details will become apparent from the description that follows.

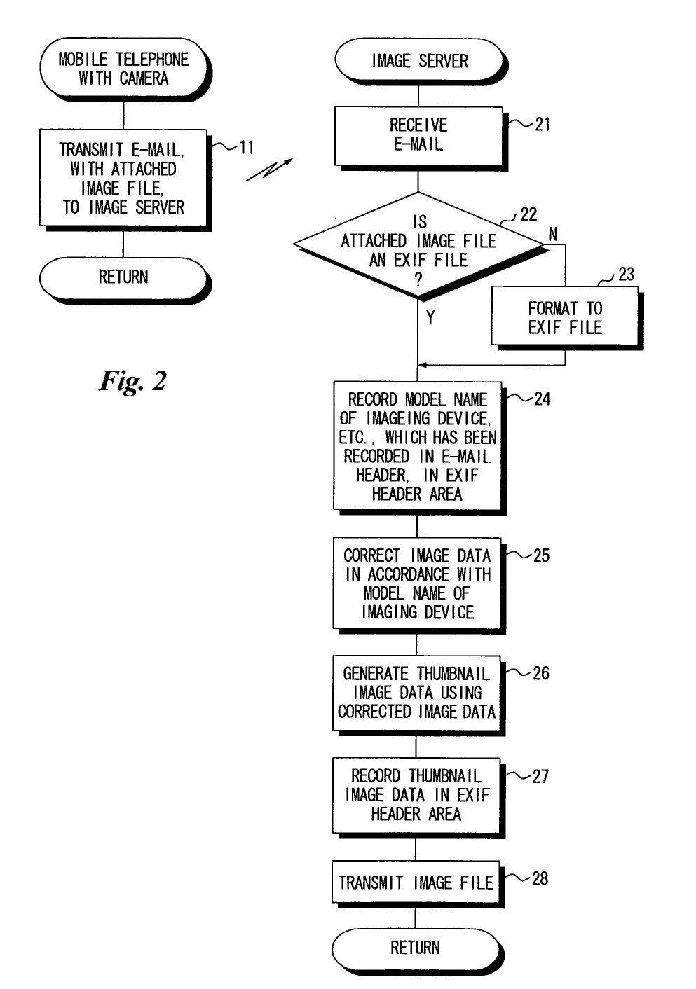

FIG. 2 is a flowchart illustrating processing executed by the mobile telephone 1 having camera and the image server 2.

The mobile telephone 1 having the camera senses the image of a subject and generates an image file containing image data representing the image of the subject. The generated image file is attached to e-mail which, as described above, is transmitted from the mobile telephone 1 to the image server 2 (step 11).

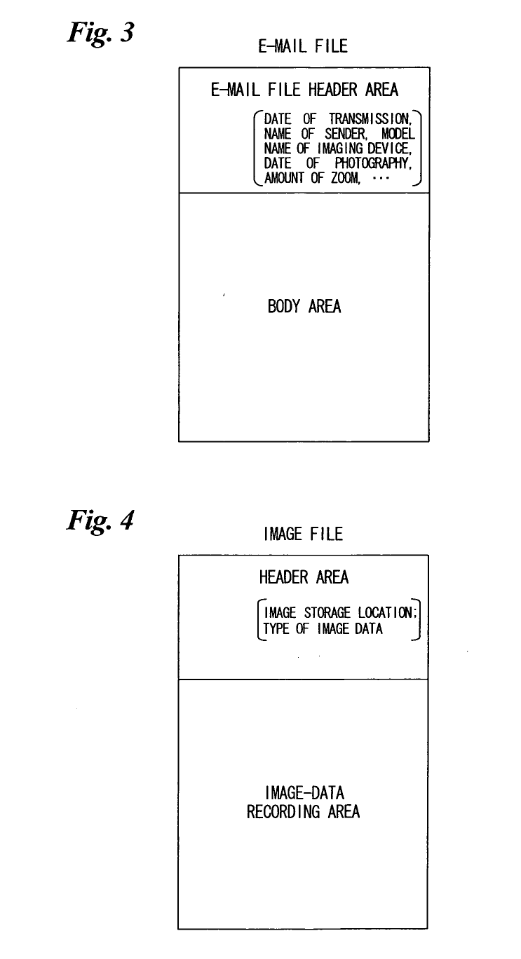

FIG. 3 illustrates the file structure (data structure) of an e-mail file.

The e-mail file includes an e-mail header area and text-body area. Data such as the date of transmission of the e-mail, the name of the sender, the model of the photographic device (the model name of the mobile telephone 1 having the camera), the date of photography and the amount of zoom is recorded in the e-mail header area. Data representing text or the like that has been entered by the user of the mobile telephone 1 is recorded in the body area.

FIG. 4 shows the file structure of an image file generated by the mobile telephone 1 having the camera.

An image file includes a header area and an image-data recording area. The storage location (image storage location) of the image data that has been recorded in the image-data recording area and the type of image data that has been recorded in the image-data recording area are recorded in the header area. The image data obtained by image sensing is stored in the image-data recording area.

Such an image file is attached to e-mail and transmitted from the mobile telephone 1 equipped with the camera to the image server 2 in the manner described above.

With reference again to FIG. 2, the e-mail that has been sent from the mobile telephone 1 having the camera is received by the image server 2 (step 21). When this occurs, the image server 2 checks to determine whether the image file attached to this e-mail is an EXIF file (step 22). If the received e-mail file is not an EXIF file (“NO” at step 22), then the file is formatted as an EXIF file (step 23). If the received file is an EXIF file, then the processing of step 23 is skipped.

Of the data that has been recorded in the e-mail header area of the received e-mail, data such as the model name of the photographic device, date of photography and amount of zoom is read from the e-mail header area and then recorded in the EXIF header (step 24). Further, image data contained in the image file that has been attached to the e-mail is read and a correction (color correction, brightness correction, etc.) conforming to the device model name that has been read from the e-mail header area is carried out (step 25). It goes without saying that a method of image correction for each model of mobile telephone having a camera will have been stored in the image server.

When the image data is corrected, thumbnail image data is generated using the corrected image data (step 26). The generated thumbnail image data is recorded in the header area of the EXIF file (step 27).

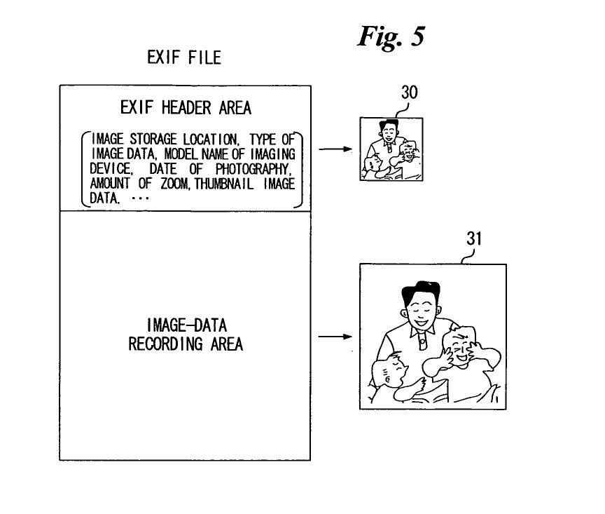

FIG. 5 illustrates the file structure of the EXIF file thus generated.

Besides the image storage location and the type of image data that has been recorded in the image-data recording area, data such as the model name of the photographic device, date of photography, amount of zoom and thumbnail image data (thumbnail image 30) that has been recorded in the e-mail header area is recorded in the EXIF header area. This data such as the model name of the photographic device, date of photography, amount of zoom and thumbnail image data has not been recorded in the header area of the image file transmitted from the mobile telephone 1 equipped with the camera.

Image data (original image 31), which has been corrected in accordance with the model of the mobile telephone 1 having the camera, is recorded in the image-data recording area.

Further, as described above, thumbnail image data that has been newly recorded in the EXIF header area is data that has been generated using corrected image data. This means that the image represented by the image data that has been recorded in the image-data recording area and the thumbnail image represented by the thumbnail image data will have undergone the same correction. For example, the two will be identical in terms of color tone.

With reference again to FIG. 2, the EXIF file thus generated is transmitted to the image file receiving apparatus 4 in response to a request from the image file receiving apparatus 4 (step 28). Since thumbnail image data has been recorded in the EXIF header, the thumbnail image is obtained in the image file receiving apparatus 4 without execution of processing for generating thumbnail image data.

In the embodiment above, data representing the model name of the photographic device, the date of photography and the amount of zoom, etc., is recorded in the mail header area of e-mail that has been transmitted to the image server 2 from the mobile telephone 1 having the camera. However, it may be so arranged that this data representing the model name of the photographic device, the date of photography and the amount of zoom, etc., is recorded in the header area of an image file attached to the e-mail.

As many apparently widely different embodiments of the present invention can be made without departing from the spirit and scope thereof, it is to be understood that the invention is not limited to the specific embodiments thereof except as defined in the appended claims.

1. An image server comprising:
a receiving device for receiving an image file transmitted from a portable image sensing device and including a header area and an image-data recording area;
a generating device for generating thumbnail image data using image data that has been recorded in the image-data recording area of the image file received by said receiving device;
a first recording controller for recording the thumbnail image data, which has been generated by said generating device, in the header area of the image file; and
a transmitting device for transmitting the image file, in the header area of which the thumbnail image data has been recorded by said first recording controller, to an image file receiving apparatus.

2. The image server according to claim 1, wherein said receiving device receives the image file and model information pertaining to the portable image sensing device, and the image server further comprises:
a correcting device for correcting the image data, which has been recorded in the image-data recording area of the image file received by said receiving device, in accordance with the model information received by said receiving device; and
a second recording controller for recording the image data, which has been corrected by said correcting device, in the image-data recording area of the image file;
said generating device generating thumbnail image data using the image data that has been corrected by said correcting device.

3. The image server according to claim 1, wherein said receiving device receives an image file together with the model information pertaining to the portable image sensing device used at the time the image file was obtained, and data representing date of photography and amount of zoom;
said first recording controller recording the thumbnail image data in the header area together with the model information and data representing the date of photography and amount of zoom.

4. A method of controlling an image server comprising the steps of:
receiving an image file transmitted from a portable image sensing device and including a header area and an image-data recording area;
generating thumbnail image data using image data that has been recorded in the image-data recording area of the image file received;
recording the generated thumbnail image data in the header area of the image file; and
transmitting the image file, in the header area of which the thumbnail image data has been recorded, to an image file receiving apparatus.

5. A program for controlling an image server so as to cause said image server to:
receive an image file transmitted from a portable image sensing device and including a header area and an image-data recording area;
generate thumbnail image data using image data that has been recorded in the image-data recording area of the image file received;
record the generated thumbnail image data in the header area of the image file; and
transmit the image file, in the header area of which the thumbnail image data has been recorded, to an image file receiving apparatus.

6. A recording medium storing the program set forth in claim 5.
